(19) United States
(12) Patent Application Publication
(10) Pub. No.: US 2019/0361399 A1
(43) Pub. Date: Nov. 28, 2019

(54) RACK AND PINION GEAR SYSTEM FOR A WATCH

(71) Applicant: Hewlett-Packard Development Company, L.P., Spring, TX (US)

(72) Inventors: Brian Spate, Houston, TX (US); Michael W. Hu, Vancouver, WA (US); Shawn Richard Piper, Vancouver, WA (US)

(73) Assignee: Hewlett-Packard Development Company, L.P., Spring, TX (US)

(21) Appl. No.: 16/332,875

(22) PCT Filed: Oct. 7, 2016
(86) PCT No.: PCT/US2016/055934

§ 371 Date: Mar. 13, 2019

(51) Int. Cl. G04B 19/24; G04B 19/26

(52) U.S. Cl. CPC G04B 19/24; G04B 39/02; G04B 19/26

(57) ABSTRACT

A glass cassette module may include a plurality of layers of glass, a first pinion gear mechanically coupled to a watch motor, a first rack comprising and interior gear meshing with the first pinion gear and layered between the plurality of layers of glass, an indicator disposed on the rack, and a digital screen to present stationary information to which the indicator indicates a value on the digital screen.

### BACKGROUND

Analog watches use hands to point to different positions along a radial dial. These hands often denote the time as indicated by numbering along and exterior radius of the face of the watch. Occasionally, these analog watches include a number of sub-dials indicating additional information apart from the time of day.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a diagram of a glass cassette module according to one example of the principles described herein.

FIG. 2 is a partial exploded view of the glass cassette module of FIG. 1 according to an example of the principles described herein.

FIG. 3 is a diagram of a watch face with a glass cassette module combined with an analog timepiece according to an example of the principles described herein.

FIGS. 4A and 4B are diagrams of rack and pinion gear systems (400, 405) according to some examples of the principles described herein.

FIG. 5 is a block diagram of a watch (500) according to an example of the principles described herein.

Throughout the drawings, identical reference numbers designate similar, but not necessarily identical, elements.

### DETAILED DESCRIPTION

As described above, analog watches implement a number of hands that usually indicate the time of day. A numbered dial usually includes numbers from 1 to 12 positioned around a circumference of a face of the watch where the hands indicate the hour, minuets, and seconds of the day. Additionally, the face of the watch may include a number of sub-dials that fit within the area of the watch face and implement additional hands to point to other information displayed on the circumference of the sub-dial.

Because the sub-dials are placed within the circumference of the numbered dial, the hands, radiating from the center of the watch face obstruct the view of the sub-dials. Consequently, the hands may block that information presented by the sub-dials or the individual hands of the sub-dial such that the user or wearer of the watch cannot determine what information is presented.

The present specification, therefore describes a glass cassette module that includes a plurality of layers of glass, a first pinion gear mechanically coupled to a watch motor, a first rack comprising and interior gear meshing with the first pinion gear and layered between the plurality of layers of glass, an indicator disposed on the rack, and a digital screen to present stationary information to which the indicator indicates a value on the digital screen.

The present specification further describes a watch handless indicator that includes a rack and pinion gear system, the rack and pinion gear system including a first rotatable gear, a first rack interposed between at least two layers of glass the first rack comprising a geared surface to engage the first rotatable gear, and an indicator defined on the surface of the first rack to indicate information on a digital screen.

Additionally, the present specification describes a watch that includes a number of digital screens, an analog time piece, and a number of sub-dials each comprising a gear and outer ring positioned between at least two layer of glass wherein the number of sub-dials move a marking defined on the outer ring as information on at least one of the number of digital screen changes.

As used in the present specification and in the appended claims, the terms “watch” or “watch face” are meant to be understood broadly as any device that provides a user with at least the time of day.

Additionally, as used in the present specification and in the appended claims, the term “a number of” or similar language is meant to be understood broadly as any positive number comprising 1 to infinity.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

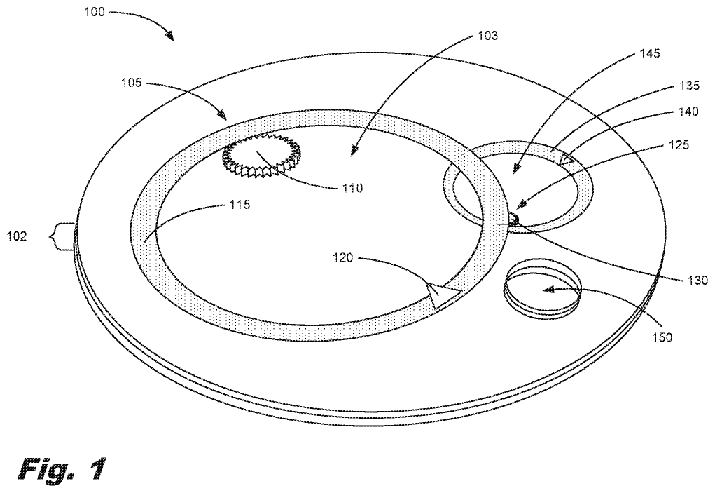

Turning now to the figures, FIG. 1 is a diagram of a glass cassette module (100) according to one example of the principles described herein. The glass cassette module (100) may be implemented in an electronic or mechanical watch or wristwatch. Examples of electronic or mechanical watches or wristwatches include spring activated watches, piezoelectric activated watches, digital watches, analog watches, or hybrid combinations of these, among others.

The glass cassette module (100) may include a first rack and pinion gear system (105) positioned within a number of layers of glass (102). The rack and pinion gear system (105) may include a first rotatable gear (110), a first rack (115), and an indicator (120) defined on the surface of the first rack (115). Each of these will now be described in more detail below.

As mentioned, the rack and pinion gear system (105) includes a first rotatable gear (110) and a first rack (115). The first rotatable gear (110) may include a number of gear teeth that engage with a number of gear teeth defined on the first rack (115), Additionally, the first rotatable gear (110) may include a center shaft extending from the center and bottom of the first rotatable gear (110). The shaft may be mechanically coupled to a watch motor within the watch the glass cassette module (100) is housed in. The watch motor may turn the gear and, accordingly, cause the first rack (115) to move.

As described above, the first rack (115) may include a number of gear teeth that engage with the gear teeth of the first rotatable gear (110), In an example, the number of gear teeth defined on the first rack (115) may be visually hidden from above via an overlapping edge defined on the first rack (115). In an example, the gear teeth defined on the first rack (115) may be exposed to viewing. In the example of FIG. 1, the first rotatable gear (110) engages the first rack (115) on the interior surface. However, this is merely meant to be an example and the first rotatable gear (110) may engage any face of the first rack (115) regardless of whether the first rotatable gear (110) is viable or not. In an example, the first rotatable gear engages with an exterior surface of the first rack (115).

The first rack (115) may be formed into any shape such that a surface of the first rack (115) has a number of gear teeth formed thereon in order to engage the first rotatable gear (110). In the example shown in FIG. 1, the first rack (115) has a ring shape with the gear teeth defined on an interior surface to engage the teeth of the first rotatable gear (110). Although FIG. 1 shows a first rack (115) in the shape of a ring, any other shape may also be used including a semicircular, a rod, a strip, or any other form. Consequently, the shape and form of the first rack (115) may vary and the present specification contemplates the use of those various forms.

The first rack (115) may further include an indicator (120) that is either physically coupled to the first rack (115) or defined on the surface of the first rack (115). The indicator (120) may be turned about the center of the first rack (115) as directed by the movement of the first rack (115). In an example, the indicator (120) may be moved above a digital screen placed behind the first rack (115) with the digital screen being viewable through a first hole (103) defined in at least one of the layers of glass (102). In the example shown in FIG. 1, the digital screen may be positioned in the behind and in center of the first rack (115). As the first rack (115) is moved around the digital screen, the indicator (120) may point to or otherwise indicate information on the screen.

The glass cassette module (100) may further include a second rack and pinion gear system (125), The second rack and pinion gear system (125) may similarly include a second rotatable gear (130), a second rack (135), and a second indicator (140), The provision of the second rack and pinion gear system (125) may be accommodated for by, in the example of FIG. 1, a second hole (145) cut from the layers of glass (102). Again, a digital screen may also be provided behind the second hole (145) which is also used as backdrop information for the second indicator (140) to point to in order to provide a user of the glass cassette module (100) additional information.

The first rack and pinion gear system (105) and the second rack and pinion gear system (125) may both be described as “sub-dials.” Although FIG. 1 shows two rack and pinion gear systems (105, 125), the present specification contemplates the use of any number of rack and pinion gear systems or “sub-dials. Consequently, the present specification contemplates the use of a single sub-dial as well as more than two sub-dials.

In further examples described below, the glass cassette module (100) including the rack and pinion gear system (105), the second rack and pinion gear system (125), or combinations thereof may be placed within a viewable space on a watch face, The watch face may therefore include an analog time piece including an hour hand, a minute hand, and/or a second hand that would travel above and radiate from the center of the glass cassette module (100). In these examples, the analog time-piece is augmented by a number of handless “sub-dials” each of which may provide additional information to the wearer or user of the watch or time piece. Consequently, the user may be provided with not only the time of day via the analog time piece of the watch but also be provided information not readily available to a user. Specifically, the digital screens placed behind the first rack and pinion gear system (105) and second rack and pinion gear system (125) may provide information to a user without the use of additional hands that could block the user's view of the subject matter described thereon. Such subject matter or information may include the day of the month, the day of the week, a personalized set of data, a lunar phase, news, various types of warnings, an exercise regime, an exercise tracker, a heart rate, an ocean tide schedule, a water depth, an altitude, a barometric pressure, a temperature, a weather report, or combinations thereof among others. This data may be uploaded to a processor or microcontroller unit (MCU) associated with at least the digital screens. A user may prepare the information to be displayed on a separate computing device and have the information uploaded to the watch. In an example, the information presented on each of the digital screens may be toggled when a user actuates a button positioned on the side or the watch. As a result, a user may create a customized information platform on the watch face that incorporates both analog and digital information. In an example, portions of the digital screen may be hidden from a user's view by applying a masking device, using a dial made of an opaque material, or other material overlaid on top of the glass cassette with cutouts to reveal the visible portions of the display, including the sub-dials or digital screens.

FIG. 1 further comprises a third hole (150). The third hole may be defined in the layers of glass (102) and may further allow a user to view content presented on a digital screen placed behind the third hole (150). The positioning of the third hole (150), second hole (145), or first hole (103) may be anywhere within a usable space on the glass cassette module (100). Additionally, the number of holes (103, 145, 150) defined in the layers of glass (102) of the glass cassette module (100) may vary and is not restricted to the number shown in the figures described herein. Indeed, any number of holes (103, 145, 150) may be defined in the layers of glass (102) so as to present additional information along with the analog time piece to the user.

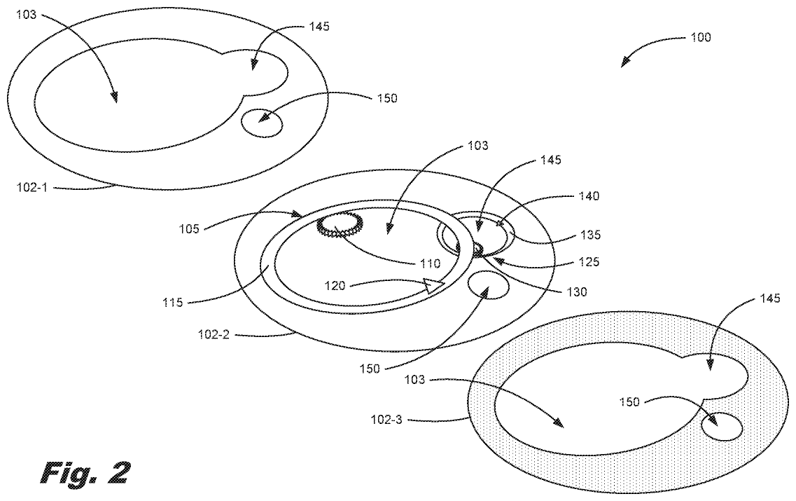

FIG. 2 is a partial exploded view of the glass cassette module (100) of FIG. 1 according to an example of the principles described herein. FIG. 2 shows the various layers of the glass cassette module (100). Although FIG. 2 shows three layers of glass (102), any number of layers may be used to accommodate the various sizes and locations of the holes (103, 145, 150) defined therein.

The layers of glass (102, 102-1, 102-2, 102-3) may each have a respective number of holes defined therein as described above for placement of the various “sub-dials” formed by at least the first rack and pinion gear system (105) and second rack and pinion gear system (125). The etching of the glass may be performed by laser etching, acid etching, grinding, or other type of subtractive manufacturing process. The amount of etching conducted in each of the layers of glass (102, 102-1, 102-2, 102-3) may vary from layer to layer, In an example, a first layer of glass (102-1) and third layer of glass (102-3) may have a smaller first hole (103) and second hole (145) defined therein in comparison to the second hole (145) defined in the second layer of glass (102-2). In this example, this may be done so that the first rack (115) and second rack (135) may be sandwiched in between two layers of glass. This allows for rotation of the first rack (115) and second rack (135) within their respective holes without falling away from the glass cassette module (100). Additionally, the thickness of the layers of glass (102) may vary depending on the thickness of the components such as the first rack and pinion gear system (105) and second rack and pinion gear system (125) sandwiched between the first (102-1) and third layer of glass (102-3). In the example shown in FIGS. 1 and 2, the thickness of the second layer of glass (102-2) may be greater than the first (102-1) and third layers of glass (102-3) in order to accommodate for the combined thicknesses of the first rack (115) and second rack (135). In an example, an additional layer of glass may be provided for each individual rack and pinion gear system to be placed in the glass cassette module (100) so that individual racks (115, 135) do not rub together as they are moved about by their respective gears (110, 130).

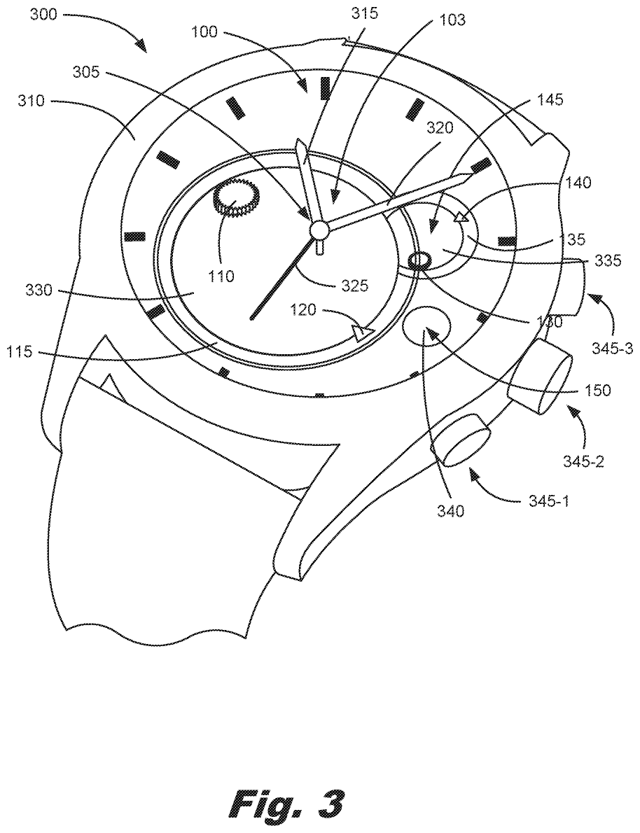

FIG. 3 is a diagram of a watch face (300) with a glass cassette module (100) combined with an analog timepiece (305) according to an example of the principles described herein. In the example of FIG. 3, the glass cassette module (100) with the first rack and pinion gear system (FIG. 1, 105) and second rack and pinion gear system (FIG. 1, 125) have been inserted into a watch housing (310). The first hole (103) provides for a conduit through which a shaft portion of the analog timepiece (305) may pass through. As described above, the analog timepiece (305) may include an hour hand (315), a minute hand (320), and a second hand (325). The analog timepiece (305) may indicate to a user the time of day.

The watch face (300) also provides for a digital screen (330, 335) behind each of the first hole (103) and second holes (145). As described above, the digital screens (330, 335) may show any type of individualized data that the user has instructed the digital screens (330, 335, 340) to show. Examples of types of digital screens that may be used include an e-ink screen and a liquid crystal display (LCD) screen, among others.

The watch face (300) may further include a number of input buttons (345-1, 345-2, 345-3) to adjust the display of the digital screens (330, 335, 340) as well as the analog timepiece (305). Although FIG. 3 shows three input buttons (345-1, 345-2, 345-3), the present specification contemplates any number of buttons that are hard key buttons, soft key buttons or combinations thereof. The input buttons (345-1, 345-2, 345-3) may allow a user to adjust the type of information displayed on the digital screens (330, 335, 340).

In an example, the watch face (300) may further include a network adapter to communicatively couple a processor within the watch face (300) to a computing device. The network adapter may include any wired or wireless communication device that allows a user to transfer data from, for example, the computing device to the watch face (300). This allows a user to upload a number of information templates to the watch face (300) comprising generic or personalized information interfaces for the user to display on the digital screens (330, 335, 340). The watch face (300) may further include a data storage device to store at least the information templates.

A power source may further be provided within the watch housing (310) to drive the analog timepiece (305), digital screens (330, 335, 340), and first and second rack and pinion gear systems (105, 125). These power sources may be mechanical, chemical, electrical power sources, or combinations thereof. In an example, the analog timepiece (305) may be actuated using mechanical power while the digital screens (330, 335, 340) and movement of the first and second rack and pinion gear systems (105, 125) are actuated using electrical or chemical power sources.

The formation of the glass cassette module (100) as described herein also provides for multiple types of glass cassette modules (100) to be manufactured and placed in a singularly designed watch housing (310). Thus, a single watch face (300) having a specifically manufactured watch housing (310) could be used to fit any number of different types of glass cassette modules (100). This allows for flexibility in producing multiple watch designs with varying sub-dial locations using a single watch housing (310). Many different possible watch designs are enabled through modifying the configuration of the glass cassette module (100) including the size of the rotatable gears (110, 130) and/or racks (115, 135) as well as their respective positions overlaid on top of the digital screens (330, 335, 340) of a single watch housing (310).

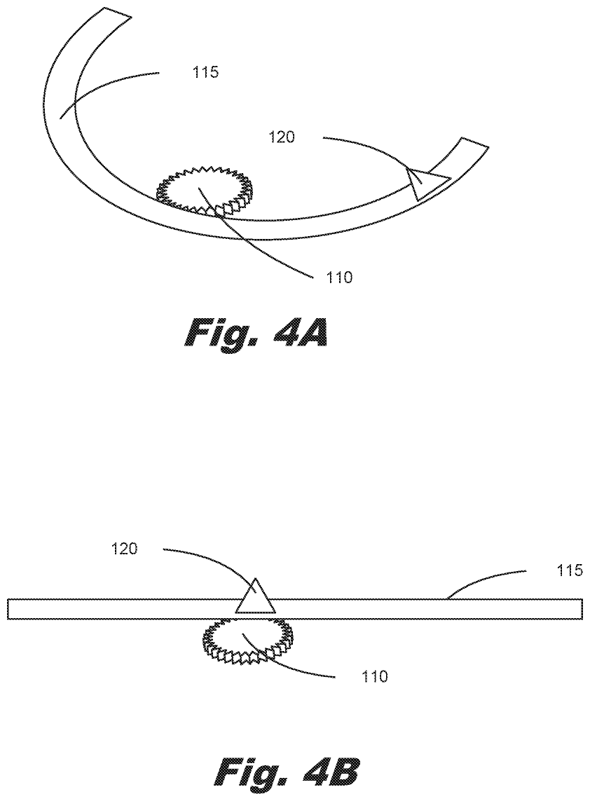

FIGS. 4A and 4B are diagrams of rack and pinion gear systems (400, 405) according to some examples of the principles described herein. FIG. 4A shows a semicircular rack (410) while FIG. 4B shows a straight rod rack (415). In both of these examples, the rack (410, 415) are again moved via a rotatable gear (110). Additionally, each rack (410, 415) includes an indicator (120) to indicate appropriate information on the digital screens (330, 335, 340) to be placed behind the racks (410, 415).

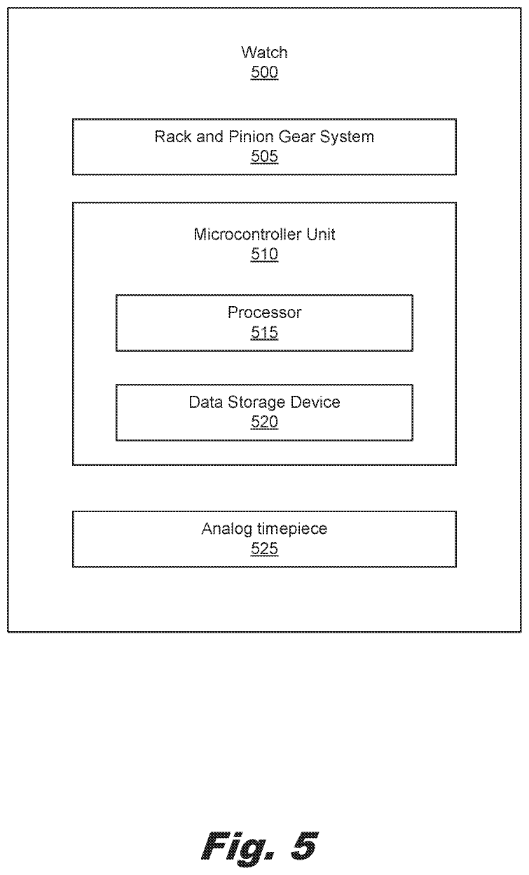

FIG. 5 is a block diagram of a watch (500) according to an example of the principles described herein. The watch (500) may include a rack and pinion gear system (505), a microcontroller unit (510) including a processor (515) and a data storage device (520), and an analog timepiece (525).

The rack and pinion gear system (505) may include a pinion gear and rack as described above in connection with FIGS. 1-4B. As described above, a rack and pinion gear system (505) may be associated with a digital screen such that an indicator on the rack may be moved by the pinion gear to properly indicate data displayed on the digital screens.

The microcontroller unit (510) may be any type of computing device. The microcontroller unit (510) may be small enough to fit within a housing of the watch (500). The microcontroller unit (510) includes a processor (515) and a data storage device (520). The processor (515) may include the hardware architecture to retrieve executable code from the data storage device (520) and execute the executable code. The executable code may, when executed by the processor (515), cause the processor (515) to implement at least the functionality of displaying data on a number of display devices in the watch (500) and activate the pinion gear of the rack and pinion gear system (505) to move the rack such that an indicator on the rack is moved to indicate the appropriate data displayed. This is according to the methods of the present specification described above and herein. In the course of executing code, the processor (515) may receive input from and provide output to a number of the remaining hardware units.

The data storage device (520) may store data such as executable program code that is executed by the processor (515) or other processing device. The data storage device (520) may specifically store computer code representing a number of applications that the processor (515) executes to implement at least the functionality described herein.

The data storage device (520) may include various types of memory modules, including volatile and nonvolatile memory, For example, the data storage device (520) of the present example includes Random Access Memory (RAM), Read Only Memory (ROM), and non-volatile memory. Many other types of memory may also be utilized, and the present specification contemplates the use of many varying type(s) of memory in the data storage device (520) as may suit a particular application of the principles described herein. In certain examples, different types of memory in the data storage device (520) may be used for different data storage needs. For example, in certain examples the processor (515) may maintain nonvolatile storage in a flash memory device and execute program code stored in Random Access Memory (RAM).

Generally, the data storage device (520) may comprise a computer readable medium, a computer readable storage medium, or a non-transitory computer readable medium, among others. For example, the data storage device (520) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a random access memory (RAM), a read-only memory (ROM), an erasable programmable read-only memory (EPROM or Flash memory), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

Aspects of the present system and method are described herein with reference to flowchart illustrations and/or block diagrams of methods, apparatus (systems) and computer program products according to examples of the principles described herein, Each of the block diagrams may be implemented using computer usable program code. The computer usable program code may be provided to a processor or other programmable data processing apparatus to produce a machine, such that the computer usable program code, when executed via, for example, the processor of the watch face or other programmable data processing apparatus, implement the functions or acts specified in the block diagrams. In one example, the computer usable program code may be embodied within a computer readable storage medium; the computer readable storage medium being part of the computer program product. In one example, the computer readable storage medium is a non-transitory computer readable medium.

The specification and figures describe a rack and pinion gear system for a watch. The system provides for a display on a watch face that is not obstructed by a number of hands. The rack includes an indicator that, when the rack is moved by the pinion gear, indicates the appropriate information on a digital screen placed behind the system. This may allow for an analog time piece to be included as well thereby creating an analog/digital hybrid watch. Additionally, the manufacturing of a glass cassette module to house the rack and pinion gear system allows for multiple configurations of a watch face without multiple forms of housings for the watch. Still further, the number and positioning of the rack and pinion gear systems may vary within the watch face allowing a manufacturer to develop multiple watch face designs without adjusting the watch housing.

The preceding description has been presented to illustrate and describe examples of the principles described. This description is not intended to be exhaustive or to limit these principles to any precise form disclosed. Many modifications and variations are possible in light of the above teaching.

What is claimed is:

1. A glass cassette module, comprising:
a plurality of layers of glass;
a first pinion gear mechanically coupled to a watch motor;
a first rack comprising and interior gear meshing with the first pinion gear and layered between the plurality of layers of glass;
an indicator disposed on the rack; and
a digital screen to present stationary information to which the indicator indicates a value on the digital screen.

2. The cassette module of claim 1, wherein the plurality of layers of glass comprise a number of grooves into which the first rack may be slidably moved.

3. The cassette module of claim 2, wherein the plurality of layers of glass comprises a number of holes defined above at least the digital screen.

4. The cassette module of claim 3, wherein the number of holes defined in the glass are two with a first hole defined above the digital screen and a second hole defined above a sub-dial offset from the rack.

5. The cassette module of claim 1, wherein the cassette module forms a sub-dial and fits below an analog watch face.

6. The cassette module of claim 1, further comprising:
a number of additional pinion gears; and
a number of additional racks offset from the first rack and each comprising and exterior gear meshing with at least one of the number of additional pinion gears.

7. The cassette module of claim 6, wherein the first and additional pinion gears are rotated by separate watch motors.

8. A watch handless indicator, comprising:
a rack and pinion gear system, the rack and pinion gear system comprising:
a first rotatable gear;
a first rack interposed between at least two layers of glass the first rack comprising a geared surface to engage the first rotatable gear; and
an indicator defined on the surface of the first rack to indicate information on a digital screen.

9. The watch handless indicator of claim 8, wherein the first rack is a straight rack.

10. The watch handless indicator of claim 8, wherein the first rack is a semi-circular rack.

11. The watch handless indicator of claim 8, further comprising:
an additional rotatable gear;
an additional rack comprising a geared surface to engage the additional rotatable gear; and
an indicator defined on the surface of the additional rack to indicate information on a digital screen placed below the additional rack.

12. A watch, comprising:
a number of digital screens;
an analog time piece; and
a number of sub-dials each comprising a gear and ring positioned between at least two layer of glass wherein the number of sub-dials move a marking defined on the outer ring as information on at least one of the number of digital screen changes.

13. The watch of claim 12, wherein the watch further comprises an input device to change the subject matter displayed on at least one of the number of digital screens.

14. The watch of claim 12, wherein each of the gears engage an outer or inner surface of a respective ring to move the respective ring.

15. The watch of claim 12, wherein the subject matter displayed on the number of digital screens comprises a day of the week, a month of the year, a current temperature, a phase of the moon, a time zone, a specified time zone time, a wind speed, a wind direction, a weather forecast, a workout reminder, a battery charge, or combinations thereof.
